(19) United States
(12) Patent Application Publication
(10) Pub. No.: US 2006/0014864 A1
(43) Pub. Date: Jan. 19, 2006

(54) Thermoplastic materials that are stabilised with polmeric phosphite esters

(76) Inventors: Thomas Braig, Dusseldorf (DE); Dietmar Bielefeldt, Ratingen (DE); Urs-Peter Dorsch, Dormagen (DE); Karsten-JPsef Idel, Krefeld (DE); Annett Konig, Leverkusen (DE); Lars Rodefeld, Leverkusen (DE); Claus-Ludolf Schultz, Krefeld (DE)

Correspondence Address: Lanxess Corporation;Law & Intellectual Property Department, 100 Bayer Road, Pittsburgh, PA, 15205-9745, US

(21) Appl. No.: 10/520,796

(22) PCT Filed: Jul. 3, 2003
(86) PCT No.: PCT/EP03/07094

§ 371 Date: Aug. 23, 2005

(30) Foreign Application Priority Data
Jul. 11, 2002 (DE) 102 31 334.2

(51) Int. Cl. C08K 5/49

(52) U.S. Cl. 524/115

(57) ABSTRACT

The invention relates to compositions based on thermoplastics, which contain polymeric phosphites.

The invention relates to compositions based on thermoplastics that contain polymeric phosphites.

Phosphites are added to polycarbonate- and polyester moulding compositions to stabilise them under thermal loads, in particular to prevent discolouration characteristics during the production of the moulding compositions by compounding and processing of the moulding compositions to form thermoplastic moulded bodies (e.g. DE-A 2 140 207, DE A 2 255 639, DE-A 2 615 341).

Phosphites are added in particular to polyalkylene terephthalates that are exposed to thermal and/or oxidative loads or strong UV radiation, to stabilise them. Stabilisation reduces polymer degradation during tempering in hot air, so that characteristics that are essential for practical application e.g. toughness and extensibility, are not reduced to such a low level as they are in non-stabilised moulding compositions (DE-A 2 615 341).

Phosphites are also added to polymer blends of polyalkylene terephthalate and polycarbonate, which have good toughness and resistance to thermoforming, to allow better varnishing ability and varnish adhesion (EP-A 0 373 465).

In addition to the stabilisation of polymer blends under thermal loads, it is also desirable to stabilise them against hydrolysis. Phosphites are equally suitable for this, as disclosed in DE-A 10 052 805.

Typical applications for moulding compositions based on polybutylene terephthalate are, for example, moulded bodies in the electronics, electrical, domestic goods, motor vehicle, medical technology and telecommunications industries, for which polybutylene terephthalate, for example, is used in non-reinforced, glass-fibre-reinforced flame-proofed and/or elastomer-modified form and/or in blends with other thermoplastics. For these applications, high resistance to long-term temperature loads and the influence of hydrolysis are required.

Surprisingly, it was found that polymeric phosphites stabilise thermoplastics significantly better against thermo-ageing and hydrolysis-ageing and have markedly better contact corrosion behaviour than low-molecular, monomeric phosphites.

The invention provides compositions containing
A) 0.01 to 5 wt. %, preferably 0.02 to 1 wt. %, particularly preferably 0.03 wt. % to 0.1 wt. % (in relation to the total composition) of polymeric phosphites, which contain, per molecule, at least one oxetane group and of which 50% or more of all molecules contain at least four monomers from the group of a di- or polyvalent phenol and/or phosphite,
B) 20 to 99.99 wt. %, preferably 30 to 61.93 wt. %, particularly preferably 40 to 41.87 parts by weight thermoplastics, selected from the group of polycarbonates, polyalkylene terephthalates, ABS, styrene polymers, polyurethanes, polyamides, polyolefins, preferably from the group of polycarbonates and polyalkylene terephthalates, in particular polybutylene terephthalate and polyethylene terephthalate, and
C) 0 to 70 wt. %, preferably 5 to 40 wt. %, particularly preferably 9 to 31 wt. % of at least one filler and reinforcing material,
D) 0 to 30 wt. %, preferably 5 to 25 wt. %, particularly preferably 9 to 19 wt. % of at least one flame-retarding additive,
E) 0 to 80 wt. %, preferably 21 to 56 wt. %, particularly preferably 31 to 51 wt. % of at least one other thermoplastic different from component B, preferably polycarbonate,
F) 0 to 80 wt. %, particularly preferably 7 to 19 wt. %, most particularly 9 to 15 wt. % of at least one elastomer modifier,
G) 0 to 10 wt. %, preferably 0.05 to 3 wt. %, particularly preferably 0.1 to 0.9 wt. % other conventional additives.
   Component A

Polymeric phosphites according to the invention are polymeric phosphite, which are also called component A below, that contain at least one oxetane group per molecule and of which 50% or more of all molecules contain at least four monomers from the group of a di- or polyvalent phenol and/or phosphite.

Phosphites of the idealised formula (Ia), (Ib), (Ic), (Id) and/or (Id), 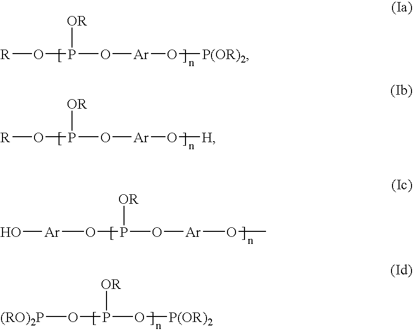
in which
n means 2 or any integer >2, preferably 2 to 10,
R means alkyl, aralkyl, cycloalkyl, aryl or phenyl or hetaryl, at least one of the groups R representing a monoalcohol containing at least one oxetane group Y, and
Ar stands for aryl, which may optionally be substituted by alkyl and/or hydroxy, and wherein 0 Ar can be the same or different
   are preferred.
   Structures 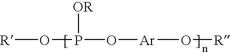
   where R′═R, HO-AR—, (RO)₂P— and
R″═(RO)₂P—, H,
wherein R and n have the meaning defined in formula (Ia) to (Id), are preferred.

For A, structures containing the following structural element 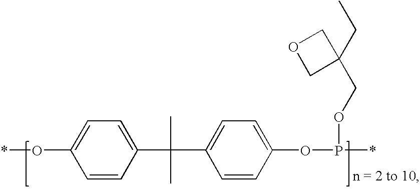
wherein
* indicates the continuation of the general structure according to formula (Ia), (Ib) or (Ic), (Id),
   are preferred in particular.

In addition to the idealised structure shown in formulae (Ia), (Ib) and/or (Ic), the polymeric phosphites according to the invention may also expressly contain the structural element (II) 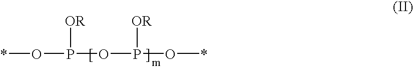
wherein
m may be 0 or any integer >0, preferably 0 to 10, and
* indicates the continuation of the general structure according to formulae (Ia), (Ib) or (Ic), (Id).

The polyphosphites according to the invention may expressly also contain branching structural elements, such as those shown for example in formulae (IIIa), (IIIb) and (IIIc) 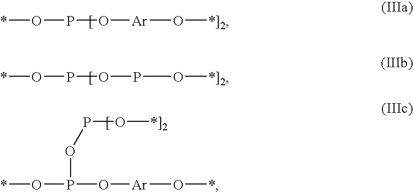
wherein
* indicates the continuation of the general structure according to one of the formulae (Ia), (Ib) or (Ic), (Id).

The following for example are suitable as groups R in formula (Ia), (Ib), (Ic), (Id), (II): H, C₁-C₁₈-alkyl, mono- or polynuclear C₃-C₁₀-cycloalkyl, phenyl-C₁-C₂-alkyl, mono- or polynuclear C₆-C₁₈-aryl, such as phenyl, naphthyl, anthracyl, phenanthryl, biphenyl, phenoxyphenyl or fluorenyl as well as heterocyclics such as tetrahydrofuryl, the aryl groups being substituted for example by alkyl and/or halogen, such as C₁-C₁₈-alkyl, chlorine and/or bromine.

The group R is preferably also a derivative of one or more C₁-C₆ monoalcohols containing oxetane groups P.

The oxetane group Y is understood to be the heterocyclic group 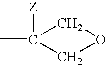
in which Z may be —CH₂—O—C₆H₁₃ or CH₂—O—C₂H₅, or preferably H, n-C₅H₁₁, —CH₂—C₅H₁₁, or very preferably CH₃, or extremely preferably C₂H₅.

The group R in formulae (Ia), (Ib), (Ic), (Id), (II) may also mean, in particular, even the oxetane group Y, for example where Z=H, CH₃, C₂H₅, in particular where Z=CH₃, C₂H₅.

The polymeric phosphites according to the invention have at least one oxetane group Y per molecule. The molar ratio of phosphorus P:oxetane group Y in the polymeric phosphites according to the invention is preferably 5:1 or less, particularly preferably 3:1 or less, most particularly preferably 2:1 or less.

The group Ar is derived from phenols having 2 phenolic hydroxyl groups. The group Ar is preferably derived from the following compounds: hydroquinone, resorcinol, catechol, di-t-butylcatechol, 4,4′-dihydroxydiphenyl, bis-(hydroxyphenyl)-alkanes such as for example C₁-C₈-alkylene or C₂-C₈-alkylidene bisphenols, bis-(hydroxyphenyl)-cycloalkanes such as for example C₅-C₁₅-cycloalkylene- or C₅-C₁₅-cycloalkylene bisphenols, α,α′-bis-(hydroxyphenyl)-diisopropylbenzene and the corresponding core-alkylated or core-halogenated compounds, for example bis-(4-hydroxyphenyl)-propane-2,2 (bisphenol A), bis-(4-hydroxy-3,5-dichlorophenyl)-propane-2,2 (tetrachlorobisphenyl A), bis-(4-hydroxy-3,5-dibromophenyl)-propane-2,2, (tetrabromobisphenol A), bis-(4-hydroxy-3,5-dimethylphenyl)-propane-2,2 (tetramethyl bisphenol A), bis-(4-hydroxy-3-methylphenyl-propane-2,2-cyclohexane-1,1 (bisphenol Z) and also α,α′-bis-(4-hydroxyphenyl)-p-diisopropylbenzene, dihydroxynaphthaline and dihydroxyanthracene.

Phloroglucinol and pyrogallol, for example, are suitable as phenols containing more than two phenolic hydroxyl groups.

Of the claimed compounds, the compounds of formulae (Ia), (Ib), (Ic), (Id), (II), (IIIa), (IIIb), (IIIc) derived from 2,2-bis-(hydroxyphenyl)-alkanes and oxetane group-containing monoalcohols are preferred, that is compounds of formulae (Ia), (Ib), (Ic), (Id), (II), (IIIa), (IIIb), (IIIc), in which Ar corresponds to a group of formula (IV) 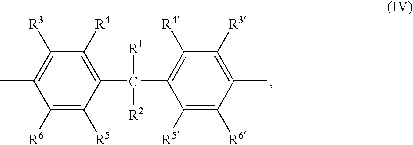
in which
R¹ and R² are the same or different and mean H, C₁-C₁₈-alkyl, mono- or polynuclear C₃-C₆-cycloalkyl or mono- or polynuclear C₆-C₁₈-aryl, preferably C₁-C₁₈-alkyl, particularly preferably methyl
R³, R^{3′}, R⁴, R^{4′}, R⁵, R^{5′}, R⁶ and R^{6′} are the same or different and mean H, C₁-C₁₈-alkyl, mono- or polynuclear C₃-C₆-cycloalkyl, mono- or polynuclear C₆-C₁₈-aryl, C₁-C₁₈-alkoxy, C₁-C₁₈-aryloxy or halogen, in particular H or C₁-C₁₈-alkyl.

The alkyl substituents suitable as substituents for compounds of formula (IV) may be unbranched or branched, saturated or unsaturated, suitable aryl substituents may be, for example, phenyl or biphenyl, Cl or Br being preferred halogen substituents.

The compounds of formulae (Ia), (Ib), (Ic), (Id), (II), (IIIa), (IIIb), (IIIc), in which Ar corresponds to a group of formula (IV), are obtained by reacting the corresponding bisphenols of formula (V) 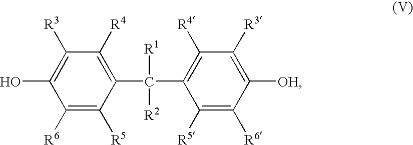
in which
R¹ to R⁶ and R^{3′} to R^{6′} have the meaning given above, by the method disclosed in DE-OS 2 255 639.

The compounds of the claimed type are high-boiling liquids, resins or solids. They are readily soluble in organic solvents, in particular in the solvents used for the production of polycarbonates and are thus particularly suitable for use as stabilisers in high-viscosity polycarbonates that are produced or processed at high temperatures.

The compounds, of which some examples are listed below, may be produced and used either individually or in mixture. The phosphites may have a linear or branched structure. Structural elements of various examples may be combined to produce new structural examples.

A selection is given below by way of example:

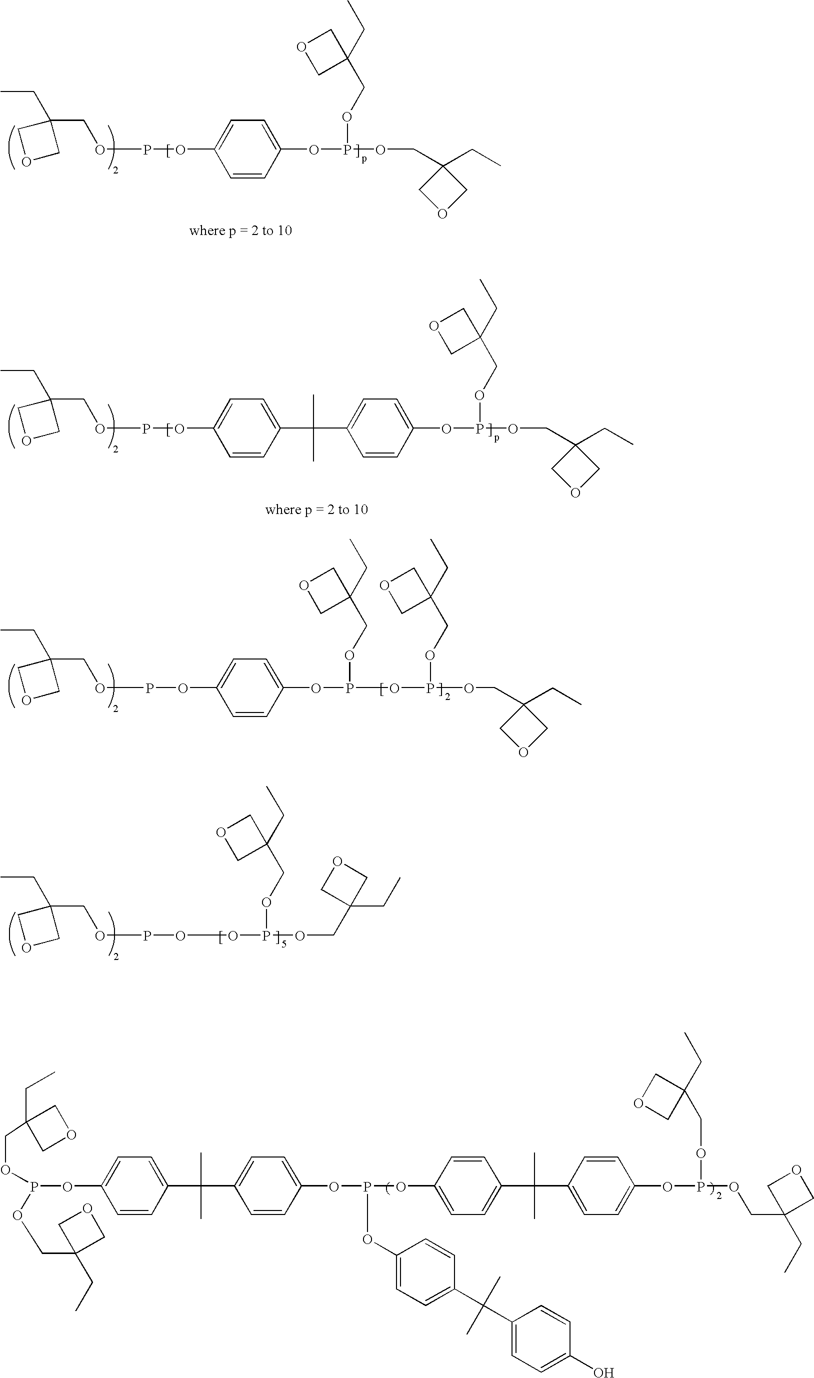

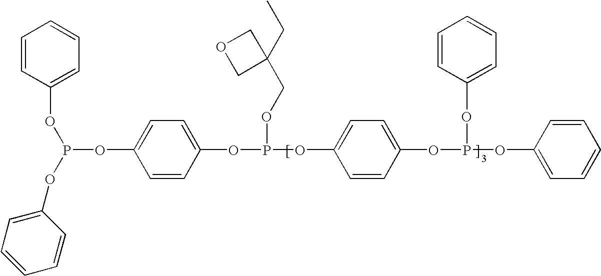

The production of low-molecular phosphites, for example of formula (Ia), (Ib), (Ic), (Id) where n=1, having at least one oxetane group residue are known in the processes disclosed in DE-A 22 55 639 (=U.S. Pat. Nos. 4,073,769 and 4,323,501).

The phosphites according to the invention of formulae (Ia), (Ib), (Ic), (Id), (II), (IIIa), (IIIb), (IIIc), in which R is the group of an oxetane group-containing monoalcohol, may be produced, for example, by reacting a mixture consisting of an oxetane group-containing monoalcohol R—OH and an aryl compound containing two or more phenolic hydroxyl groups, for example a bisphenol of formula (V), in the presence of an alkaline catalyst containing triphenylphosphite, the desired product being formed by the splitting off of phenol. The reaction temperature is 100° C.-180° C., the catalysts are NaOH, NaOCH₃, Na-phenolate, Na₂-CO₃, KOH and tributylamine. When producing polymeric phosphites of formula (Id) aryl compounds containing two or more phenolic hydroxyl groups are not added.

The reaction can take place without solvent or with the addition of solvents. The molar ratio of the reactants oxetane group-containing monoalcohol R—OH, aryl compound and triphenylphosphite, results from the average molecular composition of the polymeric end product of formula (Ia), (Ib), (Ic) or (Id) to be produced.

The polyphosphites according to the invention consist of at least 50% polymers or molecules having 4 or more monomer units, the structural elements —P═ and —Ar— of formulae (Ia-d) being deemed monomer units according to the invention. According to the invention, at least half of the polymeric phosphites of formulae (Ia-d), contain at least one molar mass of a tetramer where n=4 or more, the average molar mass of the —P(OR)O— units (formulae Ia-d) and —Ar—O— units (formulae Ia-c) used being taken as the calculation basis. According to the invention, the molar mass distribution is determined, for example, on the basis of the integral of the product signals using a refractive index (RI) detector via the elution volume in Gel Permeation Chromatography (GPC), tetrahydrofuran being used as the eluent and calibration being carried out against polystyrene standards. Gel Permeation Chromatography is preferably carried out according to DIN 55672-1.

According to the invention, mixtures of various polyphosphites according to the invention may also be added to the thermoplastics of component B).

The polyphosphites of component A) according to the invention may be added to the thermoplastics of component B) either by dosing component A) in pure form into the molten thermoplastic of component B) or optionally by dosing it in solution in a low-boiling solvent into the thermoplastic of component B). Component A) can also be dosed in by saturating the powdered or granulated thermoplastic of component B) with component A) (optionally with its solution in a solvent such as for example isopropanol) in a suitable mixing apparatus.

In a preferred embodiment, component A) can also be added as a highly-concentrated batch in a thermoplastic to the thermoplastic of component B) during the production/compounding process. The batch of component A) is produced, for example, by compounding component A) in a thermoplastic. The concentration of component A) in the batch is more than 3 wt. %, preferably more than 5 wt. %, particularly preferably more than 8 wt. %. The preferred thermoplastic for batch production is the thermoplastic used in component B). In a particularly preferred embodiment, polyalkylene terephthalate or polycarbonate, in particular polybutylene terephthalate or polycarbonate, is used as the thermoplastic for batch production, if a polyalkylene terephthalate or polycarbonate is used as component B). The batch may take granule or powder form. The batch is worked up/processed by known methods.

The same applies for the dosing of the phosphite during production of the polymer by known processes in the melt or in a solvent.

Phosphites according to the invention are also phosphites that contain, per molecule, at least one phosphorus-bonded hydroxyl group (P—OH) and at least one group of a di- or polyvalent phenol.

Component B

According to the invention, the compositions contain, as component B, a thermoplastic such as for example polyolefins, e.g. polyethylene, polypropylene, polystyrene, polyvinylchloride and/or polyoxymethylene polymers, polyimides, polyether ketones, polyethers, polyacrylates, polymethacrylates, polymethyl methacrylates, polyamides, polyesters, thermoplastic polyurethanes. The compositions preferably contain as component B at least one thermoplastic from the group of polycarbonates, polyamides, such as for example polyamide 6 or polyamide 6,6, polyesters such as for example polyalkylene terephthalates, e.g. polybutylene terephthalate or polyethylene terephthalate. According to the invention, a mixture of two or more thermoplastics is preferably used as component A. Mixtures comprising polycarbonate and polyester, such as mixtures of polycarbonate and polybutylene terephthalate or polycarbonate and polyethylene terephthalate are preferred in particular.

Partially aromatic polyesters are preferably used as component B. The partially aromatic polyesters according to the invention are selected from the group of derivatives of polyalkylene terephthalates, preferably selected from the group of polyethylene terephthalates, polytrimethylene terephthalates and polybutylene terephthalates, particularly preferably of polybutylene terephthalates, most particularly preferably of polybutylene terephthalate.

Partially aromatic polyesters are understood to mean materials that contain aliphatic molecule parts as well as aromatic molecule parts.

Polyalkylene terephthalates according to the invention are reaction products of aromatic dicarboxylic acid or its reactive derivatives (e.g. dimethylesters or anhydrides) and aliphatic, cycloaliphatic or araliphatic diols and mixtures of these reaction products.

Preferred polyalkylene terephthalates may be produced from terephthalic acid (or its reactive derivatives) and aliphatic or cycloaliphatic diols having 2 to 10 C atoms by known methods (Kunststoff-Handbuch, Vol. VIII, p. 695 ff, Karl-Hanser-Verlag, Munich 1973).

Preferred polyalkylene terephthalates contain at least 80, preferably 90 mol % in relation to the dicarboxylic acid, of terephthalic acid groups and at least 80, preferably at least 90 mol %, in relation to the diol component, of ethylene glycol- and/or propanediol-1,3- and/or butanediol-1,4 groups.

The preferred polyalkylene terephthalates may contain, in addition to terephthalic acid esters, up to 20 mol % groups of other aromatic dicarboxylic acids having 8 to 14 C atoms or aliphatic dicarboxylic acids having 4 to 12 C atoms, such as groups of phthalic acid, isophthalic acid, naphthaline-2,6-dicarboxylic acid, 4,4′-diphenyldicarboxylic acid, succinic acid, adipic acid, sebacic acid, azelaic acid, cyclohexane diacetic acid, cyclohexane dicarboxylic acid.

The preferred polyalkylene terephthalates may contain, in addition to ethylene- or propane diol-1,3- or butane diol-1,4-glycol groups, up to 20 mol % of other aliphatic diols having 3 to 12 C atoms or cycloaliphatic diols having 6 to 21 C atoms, e.g. groups of propane diol-1,3,2-ethylpropane diol-1,3, neopentylglycol, pentanediol-1,5, hexanediol-1,6, cyclohexane-dimethanol-1,4,3-methylpentanediol-2,4,2-methylpentanediol-2,4, 2,2,4-trimethylpentanediol-1,3 and -1,6,2-ethylhexanediol-1,3 2,2-diethylpropanediol-1,3, hexanediol-2,5, 1,4-di-(β-hyroxyethoxy)-benzene, 2,2-bis-(4-hydroxycyclohexyl)-propane, 2,4-dihydroxy-1,1,3,3-tetramethylcyclobutane, 2,2-bis-(3-β-hydroxyethoxyphenyl)-propane and 2,2-bis-(4-hydroxypropoxyphenyl)-propane (DE-OS 24 07 674, 24 07 776, 27 15 932).

The polyalkylene terephthalates may be branched by incorporating relatively small 1 quantities of 3- or 4-valent alcohols or 3- or 4-basic carboxylic acids, as disclosed e.g. in DE-OS 19 00 270 and U.S. Pat. No. 3,692,744.

Examples of preferred branching agents are trimesic acid, trimellitic acid, trimethylol ethane and -propane and pentaerythritol.

It is advisable to use no more than 1 mol % of the branching agent in relation to the acid component.

Polyalkylene terephthalates, which have been produced only from terephthalic acid and its reactive derivatives (e.g. its dialkyl esters) and ethylene glycol and/or propanediol-1,3 and/or butanediol-1,4 (polyethylene- and polybutylene terephthalate), and mixtures of these polyalkylene terephthalates, are preferred in particular.

Preferred polyalkylene terephthalates are also co-polyesters, which are produced from at least two of the above acid components and/or at least two of the above alcohol components, co-polyesters preferred in particular are poly-(ethylene glycol/butanediol-1,4)-terephthalates.

The polyalkylene terephthalates generally have an intrinsic viscosity of ca 0.4 to 1.5, preferably 0.5 to 1.3, measured in each case in phenol/o-dichlorobenzene (1:1 wt. %) at 25° C.

The polyesters produced according to the invention are preferably used also in mixture with other polyesters and/or other polymers. Mixtures of polyalkylene terephthalates with other polyesters are preferred in particular, most particularly mixtures of polybutylene terephthalate with polyethylene terephthalate.

Conventional additives such as e.g. mould release agents, stabilisers and/or flowing agents can be mixed into the polyesters in the melt or applied to the surface.

Component C

The thermoplastic moulding compositions contain, as component C) a filler or reinforcing material or a mixture of two or more different fillers and/or reinforcing materials based, for example, on talc, mica, silicate, quartz, titanium dioxide, wollastonite, kaolin, amorphous silicas, magnesium carbonate, chalk, feldspar, barium sulfate, glass beads and/or fibre-form fillers and/or reinforcing materials based on carbon fibres and/or glass fibres. Mineral fillers in particle form, based on talc, mica, silicate, quartz, titanium dioxide, wollastonite, kaolin, amorphous silicas, magnesium carbonate, chalk, feldspar, barium sulfate and/or glass fibres are preferred. Mineral fillers in particle form based on talc, wollastonite, kaolin and/or glass fibres are particularly preferred according to the invention.

Particularly for applications in which isotropy in dimensional stability and a high thermal dimensional stability are required, such as for example automotive external bodywork parts, mineral fillers are preferred, in particular talc, wollastonite or kaolin.

If component F) is a block copolymer, the blends preferably contain a quantity of 2.5 to 34, particularly preferably 3.5 to 28, most particularly preferably 5 to 21 wt. % mineral filler.

Acicular mineral fillers are also preferred in particular. According to the invention, acicular mineral fillers are understood to mean mineral fillers with a highly distinctive acicular character. More acicular wollastonites are an example. The mineral preferably has a ratio of length:diameter of 2:1 to 35:1, particularly preferably 3:1 to 19:1, most particularly preferably 4:1 to 12:1. The average particle size of the acicular minerals according to the invention is preferably less than 20 μm, particularly preferably less than 15 μm, in particular less than 10 μm, most particularly preferably less than 5 μm, measured with a CILAS GRANULOMETER.

Mineral fillers based on talc are also particularly preferred as component E). Possible mineral fillers based on talc according to the invention are all fillers in particle form, which the person skilled in the art combines with talc or talcum. Equally possible are all fillers in particle form that are offered commercially, and the product description of which contains the terms talc or talcum as characterising features.

Mineral fillers with a talc content to DIN 55920 greater than 50 wt. %, preferably greater than 80 wt. %, particularly preferably greater than 95 wt. % and in particular greater than 98 wt. %, in relation to the total mass of filler, are preferred.

The mineral fillers based on talc can also be surface-treated. They may, for example, be provided with a coupling agent system e.g. based on silane.

The talc-based mineral fillers according to the invention preferably have an upper particle or grain size d97 of less than 50 μm, preferably less than 10, particularly preferably less than 6 and in particular less than 2.5 μm. A value less than 10, preferably less than 6, particularly preferably less than 2 and in particular less than 1 μm is preferably selected as the average grain size d50. The d97 and d50 values of the fillers D are measured by SEDIGRAPH D 5 000 sedimentation analysis or by DIN 66 165 sieve analysis.

The average aspect ratio (diameter to thickness) of the fillers in particle form based on talc is preferably in the range 1 to 100, particularly preferably 2 to 25, and in particular 5 to 25, measured on electron microscopic recordings of ultra-thin sections of the finished products and measurement of a representative quantity (ca 50) of filler particles.

The filler and/or reinforcing material may optionally be surface-modified, for example with a coupling agent or coupling agent system e.g. based on silane. However, pre-treatment is not strictly necessary. When using glass fibres, in particular, polymer dispersions, film formers, branching agents and/or glass fibre processing auxiliary materials can be used in addition to silanes.

Glass fibres that generally have a fibre diameter of 7 to 18, preferably 9 to 15 μm and may be added as continuous fibres or cut or ground glass fibres, are preferred in particular according to the invention, and the fibres may be provided with a suitable sizing system and a coupling agent or coupling agent system e.g. based on silane.

Silane compounds commonly used for pre-treatment have the following general formula, for example
(X—(CH2)q)k-Si—(O—CrH2r+1)4-k
in which the substituents have the following meaning:
x NH2-, HO, 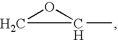
q an integer from 2 to 10, preferably 3 to 4
r an integer from 1 to 5, preferably 1 to 2
k an integer from 1 to 3, preferably 1

Preferred silane compounds are aminopropyl trimethoxysilane, aminobutyl trimethoxysilane, aminopropyl triethoxysilane, aminobutyl triethoxysilane and the corresponding silanes, which contain a glycidyl group as substituent X.

The silane compounds are generally used in quantities of 0.05 to, preferably 0.5 to 1.5 and in particular 0.8 to 1 wt. %, in relation to the mineral filler, for surface coating.

The fillers in particle form may have a lower d97 or d50 value in the moulding composition or moulded body than the filler originally used, as a result of processing into the moulding composition or moulded body. The glass fibres may have shorter length distributions in the moulding composition or moulded body than those originally used as a result of processing into the moulding composition or moulded body.

The particle diameters in the finished product may be measured, for example, by making electron-microscopic recordings of thin sections of the polymer mixture and using at least 25, preferably 50, filler particles for evaluation.

Component D

Commercial organic halogen compounds containing synergists or commercial organic nitrogen compounds or organic/inorganic phosphorus compounds can be used alone, or in mixture, as the flame retardant. Mineral flame-retarding additives such as magnesium hydroxide or Ca—Mg-carbonate hydrate (e.g. DE-A 4 236 122) may also be used. Examples of halogen-containing, in particular brominated and chlorinated, compounds are: ethylene-1,2-bistetrabromophthalimide, epoxidated tetrabromobisphenol A resin, tetrabromobisphenol A oligocarbonate, tetrachlorobisphenol A oligocarbonate, pentabromopolyacrylate, brominated polystyrene. The phosphorus compounds according to WO-A 98/17720, e.g. triphenyl phosphate (TPP), resorcinol-bis-(diphenyl phosphate) including oligomers (RDP) and also bisphenol-A-bis-diphenylphosphate, including oligomers (BDP), melamine phosphate, melamine pyrophosphate, melamine polyphosphate and mixtures thereof are suitable as organic phosphorus compounds. Melamine and melamine cyanurate, in particular, are possible nitrogen compounds. Antimony compounds, in particular antimony trioxide and antimony pentoxide, zinc compounds, tin compounds such as e.g. tin stannate, and borates, for example, are suitable synergists. Carbon formers and tetrafluoroethylene polymers may be added.

Component E

At least one further thermoplastic different from the thermoplastic used as component B, may be used according to the invention as component E.

Polycarbonates or a mixture of polycarbonates are preferably used according to the invention as component E.

Preferred polycarbonates are those homopolycarbonates and copolycarbonates based on bisphenols of the general formula (I)
HO-Z-OH (I)
in which Z is a divalent organic group having 6 to 30 C atoms, which contains one or more aromatic groups.

Bisphenols of the formula (Ia) 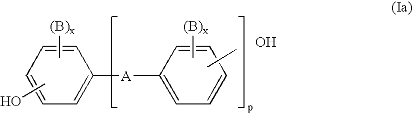
wherein
A means a single bond, C₁-C₅-alkylene, C₂-C₅-alkylidene, C₅-C₆-cycloalkylidene, —O—, —SO—, —CO—, —S—, —SO₂—, C₆-C₁₂-arylene, onto which further aromatic rings, optionally containing heteroatoms, may be condensed,
   or a group of formula (II) or (III) 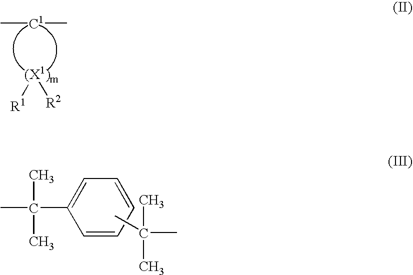
B is, in each case, C₁-C₁₂-alkyl, preferably methyl, halogen, preferably chlorine and/or bromine
x is, in each case, independently of each other, 0, 1 or 2,
p is 1 or 0 and
R¹ and R² may be selected individually for each X¹, independently of each other, as hydrogen or C₁-C₆-alkyl, preferably hydrogen, methyl or ethyl,
X¹ means carbon and
m means an integer from 4 to 7, preferably 4 or 5, provided that R¹ and R² are both alkyl on at least one X¹ atom.

Examples of bisphenols according to the general formula (I) are bisphenols that belong to the following groups: dihydroxydiphenyls, bis-(hydroxyphenyl)-alkanes, bis-(hydroxyphenyl)-cycloalkanes, indane bisphenols, bis-(hydroxyphenyl)-sulfides, bis-(hydroxyphenyl)-ethers, bis-(hydroxyphenyl)-ketones, bis-(hydroxyphenyl)-sulfones, bis-(hydroxyphenyl)-sulfoxides and α,α′-bis-(hydroxyphenyl)-diisopropylbenzenes.

Derivatives of the stated bisphenols, which are accessible for example by alkylation or halogenation on the aromatic rings of the stated bisphenols, are examples of bisphenols according to the general formula (I).

Examples of bisphenols according to the general formula (I) are in particular the following compounds: hydroquinone, resorcinol, 4,4′-dihydroxydiphenyl, bis-(4-hydroxyphenyl)sulfide, bis-(4-hydroxyphenyl)sulfone, bis-(3,5-dimethyl-4-hydroxyphenyl)-methane, bis-(3,5-dimethyl-4-hydroxyphenyl)-sulfone, 1,1-bis-(3,5-dimethyl-4-hydroxyphenyl)-p/m-diisopropyl benzene), 1,1-bis-(4-hydroxyphenyl)-1-phenyl ethane, 1,1-bis-(3,5-dimethyl-4-hydroxyphenyl)-cyclohexane, 1,1-bis-(4-hydroxyphenyl)-3-methylcyclohexane, 1,1-bis-(4-hydroxyphenyl)-3,3-dimethyl cyclohexane, 1,1-bis-(4-hydroxyphenyl)-4-methyl cyclohexane, 1,1-bis-(4-hydroxyphenyl)-cyclohexane, 1,1-bis-(4-hydroxyphenyl)-3,3,5-trimethyl cyclohexane, 2,2-bis-(3,5-dichloro-4-hydroxyphenyl)-propane, 2,2-bis-(3-methyl-4-hydroxyphenyl)-propane, 2,2-bis-(3,5-dimethyl-4-hydroxyphenyl)-propane, 2,2-bis-(4-hydroxyphenyl)-propane (i.e. bisphenol A), 2,2-bis-(3-chloro-4-hydroxyphenyl)-propane, 2,2-bis-(3,5-dibromo-4-hydroxyphenyl)-propane, 2,4-bis-(4-hydroxyphenyl)-2-methylbutane, 2,4-bis-(3,5-dimethyl-4-hydroxyphenyl)-2-methylbutane, α,α′-bis-(4-hydroxyphenyl)-o-diisopropyl benzene, α,α′-bis-(4-hydroxyphenyl)-m-diisopropyl benzene (i.e. bisphenol M), α,α′-bis-(4-hydroxyphenyl)-p-diisopropyl benzene and indane bisphenol.

Particularly preferred polycarbonates are the homopolycarbonate based on bisphenol A, the homopolycarbonate based on 1,1-bis-(4-hydroxyphenyl)-3,3,5-trimethyl cyclohexane and the copolycarbonates based on the two monomers bisphenol A and 1,1-bis-(4-hydroxyphenyl)-3,3,5-trimethyl cyclohexane.

The bisphenols disclosed according to the general formula (I) may be produced by known processes e.g. from the corresponding phenols and ketones.

The stated bisphenols and processes for producing them are disclosed for example in the monograph H. Schnell, “Chemistry and Physics of Polycarbonates”, Polymer Reviews, Volume 9, p. 77-98, Interscience Publishers, New York, London, Sydney, 1964 and in U.S. Pat. No. 3,028,635, U.S. Pat. No. 3,062,781, U.S. Pat. No. 2,999,835, U.S. Pat. No. 3,148,172, U.S. Pat. No. 2,991,273, U.S. Pat. No. 3,271,367, U.S. Pat. No. 4,982,014, U.S. Pat. No. 2,999,846, DE-A 1 570 703, DE-A 2 063 050, DE-A 2 036 052, DE-A 2 211 956, DE-A 3 832 396 and FR-A 1 561 518 and also in the Japanese unexamined specifications with the application numbers 62039/1986, 62040/1986 and 105550/1986.

1,1-bis-(4-hydroxyphenyl)-3,3,5-trimethyl cyclohexane and its production are disclosed e.g. in U.S. Pat. No. 4,982,014.

Indane bisphenols and their production are disclosed for example in U.S. Pat. No. 3,288,864, JP-A 60 035 150, U.S. Pat. No. 4,334,106. Indane bisphenols may be produced, for example, from isopropenyl phenol or its derivatives, or from dimers of isopropenyl phenol or its derivatives, in the presence of a Friedel-Craft catalyst in organic solvents.

Polycarbonates may be produced by known processes. Suitable processes for the production of polycarbonates are, for example, production from bisphenols with phosgene by the phase transfer process or from bisphenols with phosgene by the homogeneous phase process, known as the pyridine process, or from bisphenols with carbonic acid esters by the melt transesterification process. These production processes are described e.g. in H. Schnell, “Chemistry and Physics of Polycarbonates”, Polymer Reviews, Volume 9, p. 31-76, Interscience Publishers, New York, London, Sydney, 1964. The stated production processes are also described in D. Freitag, U. Grigo, P. R. Müller, H. Nouvertne, “Polycarbonates” in the Encyclopedia of Polymer Science and Engineering, Volume II, Second Edition, 1988, pages 648 to 718 and in U. Grigo, K. Kirchner and P. R. Müller “Polycarbonates” in Becker, Braun, Kunststoff-Handbuch, Volume 3/1, Polycarbonate, Polyacetale, Polyester, Celluloseester, Carl-Hanser-Verlag Munich, Vienna, 1992, pages 117 to 299 and in D. C. Prevorsek, B. T. Debona and Y. Kesten, Corporate Research Center, Allied Chemical Corporation, Morristown, N.J. 07960, “Synthesis of Poly(estercarbonate) Copolymers” in the Journal of Polymer Science, Polymer Chemistry Edition, Vol. 19, 75-90 (1980).

The melt transesterification process is described in particular in H. Schnell, “Chemistry and Physics of Polycarbonates”, Polymer Reviews, Volume 9, p. 44 to 51, Interscience Publishers, New York, London, Sydney, 1964 and in DE-A 1 031 512, U.S. Pat. No. 3,022,272, U.S. Pat. No. 5,340,905 and U.S. Pat. No. 5,399,659.

When producing polycarbonate, raw materials and auxiliary substances with a low degree of impurities are preferably used. In particular when produced by the melt transesterification process, the bisphenols and carbonic acid derivatives used must be as free as possible from alkali ions and earth alkali ions. Such pure raw materials can be obtained, for example, by re-crystallising, washing or distilling the carbonic acid derivatives, for example carbonic acid esters, and the bisphenols.

The polycarbonates suitable according to the invention preferably have a weight average molar mass (M;_w), which can be measured e.g. by ultracentrifugation or light-scattering measurement, of 10,000 to 200,000 g/mol. In particular, they have a weight average molar mass of 12,000 to 80,000 g/mol, in particular 20,000 to 35,000 g/mol.

The average molar mass of the polycarbonates according to the invention can be set, for example, in the known way by a corresponding quantity of chain stoppers. The chain stoppers may be used individually or as a mixture of various chain stoppers.

Suitable chain stoppers are both monophenols and monocarboxylic acids. Suitable monophenols are e.g. phenol, p-chlorophenol, p-tert.-butylphenol, cumylphenol or 2,4,6-tribromophenol, as well as long-chain alkylphenols, such as e.g. 4-(1,1,3,3-tetramethylbutyl)-phenol or monoalkylphenols or dialkylphenols with a total of 8 to 20 C atoms in the alkyl substituents such as e.g. 3,5-di-tert.-butylphenol, p-tert.-octylphenol, p-dodecylphenol, 2-(3,5-dimethylheptyl)-phenol or 4-(3,5-dimethylheptyl)-phenol. Suitable monocarboxylic acids are benzoic acid, alkylbenzoic acids and halogenbenzoic acids.

Preferred chain stoppers are phenol, p.-tert.-butylphenol, 4-(1,1,3,3-tetramethylbutyl)-phenol and cumylphenol.

The quantity of chain stoppers is preferably 0.25 to 10 mol %, in relation to the sum of the bisphenols used in each case.

The polycarbonates suitable according to the invention may be branched in the known way, and preferably by incorporating tri-functional or more than tri-functional branching agents. Suitable branching agents are e.g. those having three or more than three phenolic groups or those having three or more than three carboxylic acid groups.

Suitable branching agents are, for example, phloroglucinol, 4,6-dimethyl-2,4,6-tri-(4-hydroxyphenyl)-heptene-2,4,6-dimethyl-2,4,6-tri-(4-hydroxyphenyl)-heptane, 1,3,5-tri-(4-hydroxyphenyl)-benzene, 1,1,1-tris-(4-hydroxyphenyl)-ethane, tri-(4-hydroxyphenyl)-phenylmethane, 2,2-bis-[4,4-bis-(4-hydroxyphenyl)-cyclohexyl]-propane, 2,4-bis-(4-hydroxyphenyl-isopropyl)-phenol, 2,6-bis-(2-hydroxy-5′-methyl-benzyl)-4-methylphenol, 2-(4-hydroxyphenyl)-2-(2,4-dihydroxyphenyl)-propane, hexa-(4-(4-hydroxyphenyl-isopropyl)-phenyl)-terephthalic acid ester, tetra-(4-hydroxyphenyl)-methane, tetra-(4-(4-hydroxyphenyl-isopropyl)-phenoxy)-methane and 1,4-bis-(4′,4″-dihydroxytriphenyl)-methylbenzene as well as 2,4-dihydroxybenzoic acid, trimesic acid, cyanuric chloride, 3,3-bis-(3-methyl-4-hydroxyphenyl)-2-oxo-2,3-dihydroiondol, trimesic acid trichloride and α,α′,α″-tris-(4-hydroxyphenol)-1,3,5-triisopropyl benzene.

Preferred branching agents are 1,1,1-tris-(4-hydroxyphenyl)-ethane and 3,3-bis-(3-methyl-4-hydroxyphenyl)-2-oxo-2,3-dihydroindol.

The quantity of branching agents optionally to be used is preferably 0.05 mol % to 2 mol % in relation to mols of bisphenols used.

When producing the polycarbonate by the phase transfer process, for example, the branching agents may be provided with the bisphenols and the chain stoppers in the aqueous alkaline phase, or may be added dissolved in an organic solvent, together with the carbonic acid derivatives. In the transesterification process, the branching agents are preferably dosed together with the dihydroxy aromatics or bisphenols.

Preferred catalysts to be used for the production of polycarbonate by the melt transesterification process are the ammonium salts and phosphonium salts known from the literature (see for example U.S. Pat. No. 3,442,864, JP-A 14742/72, U.S. Pat. No. 5,399,659 and DE-A 19 539 290).

Copolycarbonates may also be used. Copolycarbonates according to the invention are, in particular, polydiorganosiloxane-polycarbonate block copolymers, whose weight average molar mass (M;_w) is preferably 10,000 to 200,000 g/mol, in particular 20,000 to 80,000 g/mol (measured by gel chromatography after prior calibration by light-scattering measurement or ultrcentrifugation). The content of aromatic carbonate structural elements in the polydiorganosiloxane-polycarbonate block copolymers is preferably 75 to 97.5 wt. %, particularly preferably 85 to 97 wt. %. The content of polydiorganosiloxane structural elements in the polydiorganosiloxane-polycarbonate-block copolymers is preferably 25 to 2.5 wt. %, particularly preferably 15 to 3 wt. %. The polydiorganosiloxane-polycarbonate block copolymers may be produced, for example on the basis of α,ω-bishydroxyaryloxy terminal group-containing polydiorganosiloxanes with an average degree of polymerisation of preferably Pn=5 to 100, particularly preferably Pn=20 to 80.

The polydiorganosiloxane-polycarbonate block polymers may also be a mixture of polydiorganosiloxane-polycarbonate block copolymers with conventional polysiloxane-free, thermoplastic polycarbonates, the total content of polydiorganosiloxane structural elements in this mixture being preferably 2.5 to 25 wt. %.

Such polydiorganosiloxane-polycarbonate block copolymers are characterised in that they contain in the polymer chain on the one hand aromatic carbonate structural elements (1) and on the other hand aryloxy terminal group-containing polydiorganosiloxanes (2), 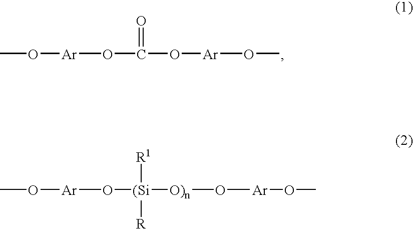
in which
Ar are the same or different difunctional aromatic groups and
R and R¹ are the same or different and mean linear alkyl, branched alkyl, alkenyl, halogenated linear alkyl, halogenated branched alkyl, aryl, or halogenated aryl, preferably methyl and
n means the average degree of polymerisation of preferably 5 to 100, particularly preferably 20 to 80.

Alkyl in the above formula (2) is preferably C₁-C₂₀-alkyl, alkenyl in the above formula (2) is preferably C₂-C₆-alkenyl; aryl in the above formula (2) is preferably C₆-C₁₄-aryl. In the above formula, halogenated means partially or fully chlorinated, brominated or fluorinated.

Examples of alkyls, alkenyls, aryls, halogenated alkyls and halogenated aryls are methyl, ethyl, propyl, n-butyl, tert.-butyl, vinyl, phenyl, naphthyl, chloromethyl, perfluorobutyl, perfluorooctyl and chlorophenyl.

Such polydiorganosiloxane-polycarbonate block copolymers and their production are disclosed for example in U.S. Pat. No. 3,189,662, U.S. Pat. No. 3,821,325 and U.S. Pat. No. 3,832,419.

Preferred polydiorganosiloxane-polycarbonate block copolymers may be produced e.g. by reacting α,ω-bishydroxyaryloxy terminal group-containing polydiorganosiloxanes together with other bisphenols, optionally also using branching agents in the conventional quantities, e.g. by the two-phase transfer process (as for example described in H. Schnell, “Chemistry and Physics of Polycarbonates”, Polymer Reviews, Volume 9, p. 31-76, Interscience Publishers, New York, London, Sydney, 1964). The α,ω-bishydroxyaryloxy terminal group-containing polydiorganosiloxanes used as educts for this synthesis, and their production, are disclosed for example in U.S. Pat. No. 3,419,634.

The polycarbonates may contain conventional additives such as e.g. mould release agents, stabilisers and/or flowing agents mixed into the melt or applied to the surface. The polycarbonates used preferably already contain mould release agents before compounding with the other components of the moulding compositions according to the invention.

According to the invention, combinations of different thermoplastics, such as for example preferably PC/polyalkylene terephthalate, PC/PBT, PC/PET, PC/ABS, may expressly also be used as component B and E. The mixtures of PC/polyalkylene terephthalate such as PC/PBT and PC/PET, in which the weight ratio PC polyalkylene terephthalate is in the range 3:1 to 1:3 are preferred in particular.

Component F

Component F comprises one or more graft polymers of
F.1 5 to 95, preferably 30 to 90 wt. % of at least one vinyl monomer
F.2 95 to 5, preferably 70 to 10 wt. % of one or more grafting bases having glass transition temperatures <10° C., preferably <0° C., particularly preferably <−20° C.

The grafting base F.2 generally has an average particle size (d₅₀ value) of 0.05 to 10 μm, preferably 0.1 to 5 μm, in particular 0.2 to 1 μm.
F.1 monomers are preferably mixtures of
F.1.1 50 to 99 wt. % vinyl aromatics and/or core-substituted vinyl aromatics (such as for example styrene, α-methylstyrene, p-methylstyrene, p-chlorostyrene) and/or methacrylic acid-(C₁-C₈)-alkyl esters (such as e.g. methyl methacrylate, ethyl methacrylate) and
F.1.2 1 to 50 wt. % vinylcyanide (unsaturated nitriles such as acrylonitrile and methacrylonitrile) and/or (meth)acrylic acid-(C₁-C₈)-alkyl esters (such as e.g. methyl methacrylate, n-butylacrylate, t-butylacrylate) and/or derivatives (such as anhydrides and imides) of unsaturated carboxylic acids (for example maleic acid anhydride and N-phenyl-maleic imide).

Preferred monomers F.1.1 are selected from at least one of the monomers styrene, α-methylstyrene and methyl methacrylate, preferred monomers F.1.2 are selected from at least one of the monomers acrylonitrile, maleic acid anhydride and methyl methacrylate.

Particularly preferred monomers are F.1.1 styrene and F.1.2 acrylonitrile.

Suitable grafting bases F.2 for the graft polymers F are, for example, diene rubbers, EP(D)M rubbers, that is, those based on ethylene/propylene and optionally diene, acrylate-, polyurethane-, silicon-, chloroprene- and ethylene/vinylacetate rubbers.

Preferred grafting bases F.2 are diene rubbers (e.g. based on butadiene, isoprene etc.) or mixtures of diene rubbers or copolymers of diene rubbers or mixtures of these with other copolymerisable monomers (e.g. according to F.1.1 and F.1.2), provided that the glass transition temperature of component F.2 is <10° C., preferably <0° C., particularly preferably <−10° C.

Pure polybutadiene rubber is preferred in particular.

Particularly preferred polymers F are e.g. ABS polymers (emulsion-, mass-, and suspension ABS), as disclosed e.g. in DE-A 2 035 390 (=U.S. Pat. No. 3,644,574) or in DE-A 2 248 242 (=GB-A 1 409 275) or in Ullmann, Enzyklopädie der Technischen Chemie, Vol. 19 (1980), p. 280 ff. The gel content of the grafting base F.2 is at least 30 wt. %, preferably at least 40 wt. % (measured in toluene).

The graft copolymers F are produced by radical polymerisation e.g. by emulsion-, suspension-, solution-, or mass polymerisation, preferably by emulsion- or mass polymerisation.

Particularly suitable graft rubbers are also ABS polymers that are produced by redox initiation with an initiator system of organic hydroperoxide and ascorbic acid according to U.S. Pat. No. 4,937,285.

As it is known that, during the grafting reaction, the graft monomers are not necessarily fully grafted onto the grafting base, products that are obtained by (co)polymerisation of the graft monomers in the presence of the grafting base and that also occur during processing are deemed also to be graft polymers B according to the invention.

Suitable acrylate rubbers according to F.2 of the polymers F are preferably polymers of acrylic acid alkyl esters, optionally containing 40 wt. %, in relation to F.2 of other polymerisable, ethylenically unsaturated monomers. The preferred polymerisable acrylic acid esters include C₁-C₈ alkyl esters, for example methyl, ethyl, butyl, n-octyl and 2-ethylhexyl esters; halogen alkylesters, preferably halogen-C₁-C₈-alkyl esters, such as chloroethylacrylate and also mixtures of these monomers.

Monomers having more than one polymerisable double bond may be copolymerised for crosslinking purposes. Preferred examples of crosslinking monomers are esters of unsaturated monocarboxylic acids having 3 to 8 C atoms and unsaturated monovalent alcohols having 3 to 12 C atoms, or saturated polyols having 2 to 40H groups and 2 to 20 C atoms, such as e.g. ethylene glycol dimethacrylate, allyl methacrylate; polyunsaturated heterocyclic compounds such as e.g. trivinyl- and triallyl cyanurate; polyfunctional vinyl compounds, such as di- and trivinyl benzenes; and also triallyl phosphate and diallyl phthalate.

Preferred crosslinking monomers are allyl methacrylate, ethylene glycol dimethacrylate, diallyl phthalate and heterocyclic compounds, which have at least 3 ethylenically unsaturated groups.

Particularly preferred crosslinking monomers are the cyclic monomers triallyl cyanurate, triallyl isocyanurate, triacryloyl hexahydro-s-triazine, triallyl benzenes. The quantity of crosslinked monomers is preferably 0.02 to 5, in particular 0.05 to 2 wt. %, in relation to grafting base F.2.

It is advantageous to restrict the quantity of cyclically-crosslinking monomers having at least 3 ethylenically unsaturated groups to below 1 wt. % of grafting base F.2.

Preferred “other” polymerisable, ethylenically unsaturated monomers, which, in addition to the acrylic acid esters, may optionally also serve for the production of the grafting base F.2, are e.g. acrylonitrile, styrene, α-methylstyrene, acrylamide, vinyl-C₁-C₆-alkyl ether, methylmethacrylate, butadiene. Preferred acrylate rubbers as grafting base F.2 are emulsion polymers, which have a gel content of at least 60 wt. %.

Other suitable grafting bases according to F.2 are silicon rubbers with graft-active sites, as disclosed in DE-A 3 704 657, DE-A 3 704 655, DE-A 3 631 540 and DE-A 3 631 539.

The gel content of grafting base F.2 is measured at 25° C. in a suitable solvent (M. Hoffmann, H. Krömer, R Kuhn, Polymeranalytik I und II, Georg Thieme-Verlag, Stuttgart 1977).

The average particle size d₅₀ is the diameter above and below which 50 wt. % each of the particles lie. It can be measured by ultracentrifugal measurement (W. Scholtan, H. Lange, Kolloid, Z. und Z. Polymere 250 (1972), 782-1796).

Component G

Component G is additives. Conventional additives are e.g. stabilisers (for example UV stabilisers, thermo-stabilisers, gamma ray stabilisers), antistatics, flow auxiliary agents, mould release agents, fire protection additives, emulsifiers, nucleation agents, plasticisers, mould lubricants, dyes and pigments. These and other suitable additives are described, for example, in Gächter, Müller, Kunststoff-Additive, 3^{rd} Edition, Hanser-Verlag, Munich, Vienna, 1989. The additives may be used alone or in mixture or in the form of master batches.

Sterically-hindered phenols, hydroquinones, aromatic secondary amines, such as diphenyl amines, substituted resorcinols, salicylates, benzotriazols and benzophenones, as well as various substituted examples from these groups and mixtures thereof, for example, may be used as stabilisers.

Titanium dioxide, ultramarine blue, iron oxide, carbon black, phthalocyanins, quinacridones, perylenes, nigrosin and anthraquinones, for example, may be used as pigments.

Sodium phenylphosphinate, aluminium oxide, silicon dioxide and also, preferably, talcum, for example, may be used as nucleation agents.

Ester waxes, pentaerythritol tetrastearate (PETS), long-chain fatty acids (e.g. stearic acid or behenic acid), their salts (e.g. Ca- or Zn-stearate) and also amide derivatives (e.g. ethylene-bis-stearylamide) or montan waxes (mixtures of straight-chain, saturated carboxylic acids with chain lengths of 28 to 32 C atoms) as well as low-molecular polyethylene- or polypropylene waxes, may be used as mould lubricants and mould release agents.

Phthalic acid dioctyl esters, phthalic acid dibenzyl esters, pthalic acid butylbenzyl esters, hydrocarbon oils, N-(n-butyl)benzene sulfonamide, for example, may be used as plasticisers.

The compositions according to the invention are produced by mixing the components by processes known per se. The components are mixed by mixing the relevant portions by weight of the components. The components are preferably mixed at room temperature (preferably 0 to 40° C.) and/or at temperatures of 220 to 330° C. by blending, mixing, kneading, extruding or rolling the components together. It may be advantageous to pre-mix some of the components. It may also be advantageous to produce moulded parts or semi-finished products directly from a physical mixture (dry blend) of pre-mixed components and/or individual components produced at room temperature (preferably 0 to 40° C.).

The invention further provides processes for the production of the compositions and their use, and for the production of moulded parts and the moulded parts themselves.

The polymeric phosphites according to the invention are characterised by very good stability characteristics for thermoplastics, preferably of moulding compositions containing polycarbonate, polyester and/or polyalkylene terephthalate, in comparison with low-molecular phosphites, in particular with regard to thermo- and hydro-stabilisation. Furthermore, the contact corrosion behaviour in compositions containing the polymeric phosphites according to the invention is markedly better than that of low-molecular phosphites.

### EXAMPLES

Component A1: Polymeric Polyphosphite

456 g triphenyl phosphite, 375 g 3-ethyl-3-hydroxymethyl oxetane, 225 g bisphenol A and 2.5 g sodium phenolate are provided in a nitrogen atmosphere at 40° C. A vacuum is then established at 100 mbar. The mixture is heated to 115° C. within one hour and stirred for half an hour. It is then refluxed for half an hour at 10 mbar and distilled at 1 mbar to a maximum bottom temperature of 170° C. After adding 1.5 g 75% phosphite, it is heated to 190° C. After cooling the bottom was a colourless composition, highly viscous at room temperature, which was used as component A1. The product has a weight average Mw=1150 g/mol and a number average Mn=656 g/mol in GPC. The molar mass of a structural element that, according to formulae (Ia-c) contains four monomer units, two of which are bisphenol A monomers and two phosphite monomers with the structure 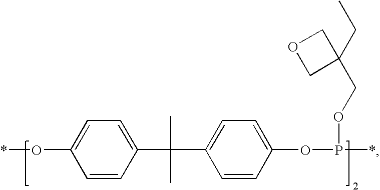
was calculated as 744 g/mol. A mass content of 52% with a molecular weight of 800 g/mol or more was measured by integration of the product signals via the elution volume in Gel Permeation Chromatography (GPC), so that at least 50 wt. % of the reaction product consists of at least four monomers.

After heating to 60° C., component A1 was mixed with PBT powder of component B and used in this form for compounding. Table 1 shows the actual content of phosphite in relation to the total composition.

Stabiliser S1: Used as a reference for the low-molecular phosphite phosphite-(1-methethylidene)di-4,1-phenylene-tetrakis(3-ethyl-(3-oxetanyl)methyl)-ester CA:53184-75-1). The phosphite was used as a master batch (10%) in polybutylene terephthalate (PBT) of component B) from Bayer AG, Leverkusen, Germany, with an intrinsic viscosity IV=0.95 cm³/g. Table 1 gives the actual content of phosphite in relation to the total composition (as example 1 of DE-A 22 55 639).

Stabiliser S2: The non-oxetane-functionalised phosphite tetrakis(2,4-di-tert.-butylphenyl)(1,1-biphenyl)4,4′-diylbiphosphonite), which can be obtained under the name IRGAFOS PEPQ-FF from Ciba Geigy GmbH, Frankfurt, was used as a reference.

Component B: linear polybutylene terephthalate (Pocan B 1300, commercial product of Bayer AG, Leverkusen, Germany) with an intrinsic viscosity of ca 0.93 cm³/g (measured in phenol: 1,2-dichlorobenzene=1:1 at 25° C.).

Component C: Glass fibres sized with silane-containing compounds, having a diameter of 10 μm (CS 7967, commercial product of Bayer Antwerpen N.V., Antwerp, Belgium)

Conventional nucleation agents and mould release agents were used as additives.

The examples in tables 1 and 2 were compounded in a twin-screw extruder of the type ZSK32 (Werner und Pfleiderer) at mass temperatures of 260° C. to 290° C.

The test bodies were injection moulded in an Arburg 320-210-500 injection moulding machine at a composition temperature of ca 260° C. and a mould temperature of ca 80° C. into shoulder bars (3 mm thick to ISO 527) and 80×10×4 mm (to ISO 178).

Except for the MVR measurements, all tests listed in table 1 were carried out on the above shoulder bars.

The hot air ageing (elongation at break) tests listed in table 2 were carried out on the above shoulder bars; all tests for resistance to hydrolysis (boundary fibre strain at bending strength, COOH) were carried out on the above 80×10×4 mm bars.

When determining the COOH terminal groups, specimen material is also dissolved in cresol/chloroform and then subjected to photometric titration.

Elongation at break: determined to DIN/EN/ISO 527-2/1A on the above-mentioned shoulder bars in the tensile test.

Boundary fibre strain at bending strength: determined to DIN/ISO 178

MVR: Flowability to DIN/ISO 1133 at 260° C. and 2.16 kg.

GPC: eluent: tetrahydrofuran, refractive index (RI) detector, method according to DIN 55672-1, calibrated against polystyrene standards.

The hydrolysis tests are carried out by storing the test bodies in a Varioklav steam steriliser (type 300/400/500 EP-Z) at 100° C. in a saturated steam atmosphere.

Thermal ageing of the test bodies was carried out at 110° C. in an air-circulating drying oven.

Contact corrosion: To determine contact corrosion, a bronze strip (CuSn6 alloy from Möller, Bonn) 4 cm in length was stored half in granulate and half in air, in an Erlenmeyer flask in an air-circulating drying cabinet at 140° C. The discolouration/corrosion of the bronze strip is rated: ++=very good=no discolouration/corrosion; +=good=hardly any discolouration/corrosion; o=moderate=moderate discolouration/corrosion; −=poor=significant discolouration/corrosion.

As can be seen from table 1, the moulding compositions according to the invention (Ex. 1) have higher values for elongation at break in the tensile test and/or lower COOH terminal group contents than reference examples 1 and 2, after hot air ageing for 336 hours and 672 hours and after storage in steam for 72 hours, 168 hours and 240 hours. Lower COOH terminal group contents and higher values for elongation at break after storage in steam indicate lower polymer damage by polymer degradation and point to the improved thermo- and hydrolysis resistance and thus improved stabilisation characteristics of component A. Ex. 1 containing polymeric phosphites also has the best contact corrosion characteristics in comparison with the low-molecular stabilisers in references 1 and 2.

As can be seen from table 2, glass-fibre-reinforced moulding compositions according to the invention (Ex. 2) have higher values for elongation at break in the tensile test after hot air ageing for 336 hours and 672 hours. The boundary fibre strain at bending strength in the bending test, which is particularly meaningful for hydrolysis resistance, of glass-fibre-reinforced thermoplastics is consistently higher after storage in steam for 72 hours, 168 hours and 240 hours for the moulding compositions according to the invention (Ex. 2) than for the reference example containing low-molecular stabiliser (Ref. 3). The COOH terminal group contents for Example 2 after storage in steam for 72 hours, 168 hours and 240 hours are lower than for Ref. 3. These results prove lower polymer damage by polymer degradation and show the improved thermo- and hydrolysis resistance, and thus improved stabilising characteristics, of component A. Ex. 2 containing polymeric phosphites also has the best contact corrosion characteristics in comparison with the low-molecular stabiliser in Ref. 3.

TABLE 1

| | | Ref.1 | Ref.2 | Ex.1 |
|---|---|---|---|---|
| Component A | [%] | — | — | 0.10 |
| Component B | [%] | 99.5 | 99.5 | 99.5 |
| Stabiliser S1 | [%] | 0.1 | — | — |
| Stabiliser S2 | [%] | — | 0.10 | — |
| Additives | [%] | 0.40 | 0.40 | 0.40 |
| MVR at 26O° C./2.16kg | [cm³/10 min] | 60.5 | 63.8 | 62.9 |
| Elongation at break just after | [%] | 18.7 | 22.9 | 21.2 |
| injection before hydrolysis or hot air | | | | |
| ageing | | | | |
| Elongation at break after 336 h hot | [%] | 12.8 | 19.1 | 22.2 |
| air ageing at 110° C. | | | | |
| Elongation at break after 672 h hot | [%] | 8.9 | 10.0 | 10.2 |
| air ageing at 110° C. | | | | |
| COOH terminal groups just after | [mmol/kg] | 21 | 24 | 20 |
| injection, before hydrolysis or hot | | | | |
| air ageing | | | | |
| COOH terminal groups after 336 h | [mmol/kg] | 23 | 24 | 22 |
| hot air ageing at 110° C. | | | | |
| Elongation at break after 72 h | [%] | 11.2 | 11.2 | 13.8 |
| hydrolysis | | | | |
| Elongation at break after 168 h | [%] | 4.3 | 3.2 | 4.8 |
| hydrolysis | | | | |
| Elongation at break after 240 h | [%] | 0.6 | 0.6 | 1.3 |
| hydrolysis | | | | |
| COOH terminal groups after 72 h | [mmol/kg] | 31 | 33 | 31 |
| hydrolysis | | | | |
| COOH terminal groups after 168 h | [mmol/kg] | 47 | 51 | 47 |
| hydrolysis | | | | |
| COOH terminal groups after 240 h | [mmol/kg] | 64 | 68 | 62 |
| hydrolysis | | | | |
| Corrosion of bronze strips after 240 | | + | O | ++ |
| h | | | | |

TABLE 2

| | | Ref. 3 | Ref. 2 |
|---|---|---|---|
| Component A | [%] | — | 0.10 |
| Component B | [%] | 78.6 | 78.6 |
| Component C | [%] | 20.0 | 20.0 |
| Stabiliser S1 | [%] | 0.10 | — |
| Stabiliser S2 | [%] | — | — |
| Additives | [%] | 0.40 | 0.40 |
| MVR at 260° C./2.16 kg | [cm³/10 min] | 23.5 | 23.6 |
| Elongation at break just after injection | [%] | 3.4 | 3.5 |
| before hot air ageing | | | |
| Elongation at break after 336 h hot air | [%] | 3.3 | 3.5 |
| ageing 110° C. | | | |
| Elongation at break after 672 h hot air | [%] | 3.2 | 3.5 |
| ageing 110° C. | | | |
| Boundary fibre strain at bending | [%] | 4.2 | 4.5 |
| strength just after injection before | | | |
| hydrolysis | | | |
| Boundary fibre strain at bending | [%] | 3.1 | 3.2 |
| strength after 72 h hydrolysis | | | |
| Boundary fibre strain at bending | [%] | 2.5 | 2.5 |
| strength after 168 h hydrolysis | | | |
| Boundary fibre strain at bending | [%] | 1.9 | 2.0 |
| strength after 240 h hydrolysis | | | |
| COOH terminal groups just after | [mmol/kg] | 18 | 16 |
| injection before hydrolysis or hot air | | | |
| ageing | | | |
| COOH terminal groups after 72 h | [mmol/kg] | 27 | 22 |
| hydrolysis | | | |
| COOH terminal groups after 168 h | [mmol/kg] | 38 | 36 |
| hydrolysis | | | |
| COOH terminal groups after 240 h | [mmol/kg] | 51 | 48 |
| hydrolysis | | | |
| Corrosion of bronze strips after 240 h | | + | ++ |

1. Compositions containing
A) 0.01 to 5 wt. % (in relation to the total composition) polymeric phosphites, which contain, per molecule, at least one oxetane group and of which 50% or more of all molecules contain at least four monomers from the group of a di- or polyvalent phenol and/or phosphite.
B) 20 to 99.99 wt. % thermoplastics, selected from the group of polycarbonates, polyalkylene terephthalates, ABS, styrene polymers, polyurethanes, polyamides, polyolefins and
C) 0 to 70 wt. % of at least one filling and reinforcing material
D) 0 to 30 wt. % of at least one flame-retarding additive
E) 0 to 80 wt. % of at least one further thermoplastic, different from component B
F) 0 to 80 wt. % of at least one elastomer modifier
G) 0 to 10 wt. % of other conventional additives.

2. Compositions containing
A) 0.03 wt. % to 0.1 wt. % (in relation to the total composition) polymeric phosphites, which contain, per molecule, at least one oxetane group and 50% or more of all molecules of which contain at least four monomers from the group of a di- or polyvalent phenol and/or phospite,
B) 30 wt. % to 41.87 wt. % thermoplastic, selected from the group of polycarbonates, polyalkylene terephthalates, ABS, styrene polymers, polyurethanes, polyamides, polyolefins and
C) 9 to 31 wt. % of at least one filling and reinforcing material,
D) 9 to 19 wt. % of at least one flame-retarding additive,
E) 31 to 51 wt. % of at least one further thermoplastic different from component B,
F) 9 to 15 wt. % of at least one elastomer modifier,
G) 0.1 to 0.9 wt. % of other conventional additives.

3. Compositions according to claims 1 or 2, wherein B) is a thermoplastic, selected from the group of polycarbonates and polyalkylene terephthalates.

4. Compositions according to claims 1 or 2, wherein B) is selected from polybutylene terephthalate.

5. Compositions according to claims 1 or 2, wherein E) is polycarbonate.

6. Compositions according to claims 1 or 2, wherein phosphites of the formula (Ia), (Ib), (Ic) and/or (Id), 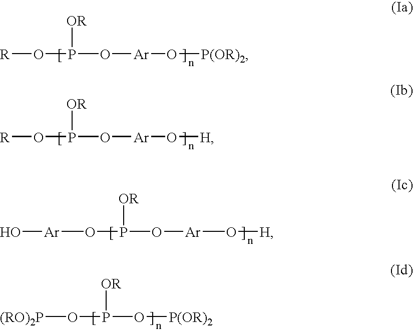
in which
n means 2 or any integer >2, preferably 2 to 10,
R means alkyl, aralkyl, cycloalkyl, aryl or phenyl or hetaryl, at least one of the R groups carrying an oxetane group, and
Ar represents aryl, which may optionally be substituted by alkyl and/or hydroxy, Ar being the same or different,
are used as A).

7. Compositions according to claims 1 or 2, the oxetane group of component A being a heterocyclic group 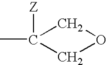
where Z is equal to —CH₂—O—C₆H₁₃, or CH₂—O—C₂H₅ or preferably H, n-C₅H₁₁, —CH₂—C₅H₁₁, or most preferably CH₃, or extremely preferably C₂H₅.

8. Compositions according to one or more of the preceding claims, containing, as component A, the compounds 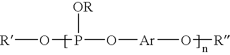
where R′═R, HO-AR—, (RO)₂P—
and R″=(RO)₂P—, H.

9. Compositions according to claims 1 or 2, wherein compounds that contain the following structural element: 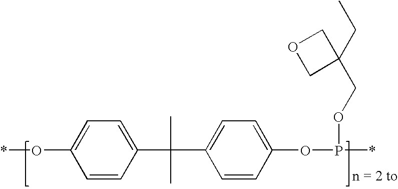
are used as component A.

10. Composition according to claim 1, wherein C=0 wt. %.

11. Composition according to claim 1, wherein glass fibres are used as component C.

12. Use of the compositions according to claims 1 or 2 for the production of moulded bodies.

13. Moulded bodies produced according to claims 1 or 2.
